(19) United States
(12) Patent Application Publication
(10) Pub. No.: US 2006/0166714 A1
(43) Pub. Date: Jul. 27, 2006

(54) Wireless personal listening device

(75) Inventors: Thomas Michael Rauscher, Oceanside, CA (US); Michael James Morgan, Oceanside, CA (US); Efrain Eliseo Quintero, Oceanside, CA (US)

Correspondence Address: Thomas Michael Rauscher, 2257 Via Blanca, Oceanside, CA, 92054, US

(73) Assignee: Rauscher Industries

(21) Appl. No.: 11/040,720

(22) Filed: Jan. 24, 2005

(51) Int. Cl. H04M 1/00

(52) U.S. Cl. 455/575.2

(57) ABSTRACT

A wireless personal listening device comprising a transmitter that is connected via wiring or directly built into an electronic device and transmits wirelessly via radio frequency to the receiver that is attached or built into the listening device which reconstructs the radio frequency signal in its originally transmitted form.

A Wireless Personal Listening Device that receives, transmits of radio waves for personal electronic devices which include but not limited to, MP3 Players, CD player, DVD player or Am/Fm Radio.

### BACKGROUND OF THE INVENTION

Field of endeavor is personal RF device for personal electronics.

1. Patents on Personal Listening Devices along with their reference numbers

A. No prior art.

1B. Patents on wireless headphone devices

A. 5574443

B. 5822023

C. 5927784

D. 6292236

E. 6304173

### SUMMARY

Problems:
a. Wires get tangled in extremities.
b. Wires snag on external objects.
c. Wires tangling or snagging can cause personal injury.
d. Wires tangling and snagging can cause damage to unit.

Similar to but better because:
a. Eliminates wires from tangling up in extremities.
b. Eliminates wires from snagging on external objects.
c. Prevents personal injuries from snagging and tangling wires.
d. Prevents damage to personal electronics from tangling and snagging wires.
e. Wireless provides higher comfort and convenience when using personal electronic devices.

### DESCRIPTION OF DRAWINGS

FIG. 1 is an abstract of the Personal Listening Device in operation.

FIG. 2 is a system block diagram of the Personal Listening Device.

FIG. 3 is a block diagram of the transmitter of the Personal Listening Device.

FIG. 4 is a block diagram of the receiver of the Personal Listening Device.

### DESCRIPTION OF PREFERRED EMBODIMENT

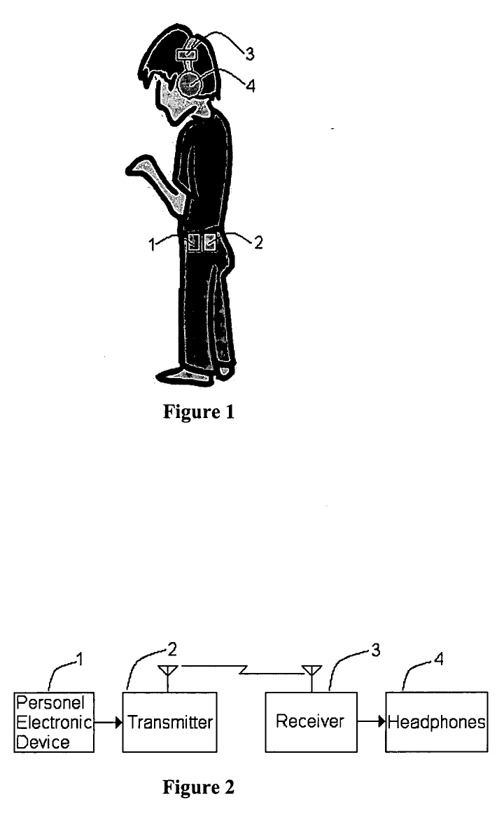

FIGS. 1 and 2 shows the Wireless Personnel Listening Device in its simplest form while FIG. 2 shows it in a black diagram.

The Wireless Personal Listening Device is able to transmit and receive audio radio frequency signals from personal electronic devices (1) such as, but not limited to, MP3 players, CD player, DVD player or AM/FM Radio.

In FIG. 1, the wireless Personnel Listening Device includes a transmitter (2) that is connected, but not limited to, via wiring or directly built into personal electronic devices (1) and transmits wirelessly via RF, but not limited to, audio produced by the personnel electronic device (1) to the receiver (3) that is attached or built into to the listening device (4) which reconstructs the RF audio signal in its originally transmitted form.

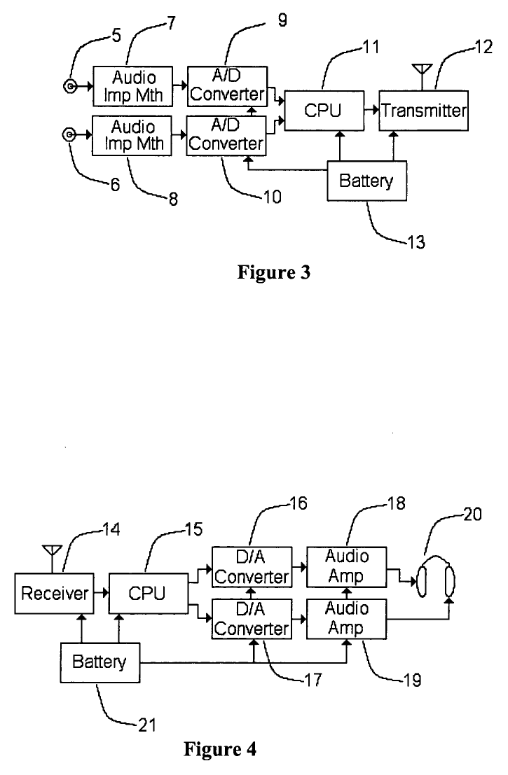

FIG. 3 shows a detailed block diagram of the transmitter (2) on FIG. 1. FIG. 3 audio inputs (5) and (6) are stereo inputs for left and right channel from the personnel electronic device (1) in FIG. 1. FIG. 3 audio impedance matching (7) and (8) provides audio impedance matching from the personnel electronic device (1) in FIG. 1 to the wireless personnel listening device transmitter (2) in FIG. 1. FIG. 3 A/D converters (9) and (10) converts audio signals to digital signals so that the CPU (11) can packet the digital signals and send them to the transmitter (12) for RF transmission. FIG. 3 battery (13) supplies power to the above circuits

FIG. 4 shows a detailed block diagram of the receiver (3).

FIG. 4, receiver (14) receives the RF signal transmitted by (2) in FIG. 1. FIG. 4, CPU (15) takes the received packets from the receiver (14) and sends them to the D/A converters (16) and (17). and converts the digital signals to audio signals. FIG. 4 audio amps (18) and (19) amplify the audio signals for the listening device (20). FIG. 4, battery (21) supplies power to the above circuits.

We claim the following:

1. Transmitting and receiving, via RF, audio from a personal electronic device but not limited to:
a. Ultra Sonic
b. Inferred
c. Inductance

2. The apparatus of claim 1, wherein:
receives audio from the personal electronic device and transmits it to the receiver listening device worn by user of the personal electronic device such as, but not limited to, MP3 Player, CD Player, DVD Player or AM/FM Radio.

3. The apparatus of claim 1, wherein:
in the short-range mode, range is approximately, but not restricted to, three (3) feet.

4. The apparatus of claim 1, wherein:
in the long-range mode, unobstructed range is approximately, but not restricted to, one thousand (1000) feet.

5. The apparatus of claim 1, wherein:
In all modes, radio has the ability to change frequency so as not to interfere with other devices in its frequency range.

6. The Wireless Personal Listening Device provides an increase in personal and product safety.

7. The apparatus of claim 6: wherein:
elimination of wires tangling up in extremities that may cause personal injury.

8. The apparatus of claim 6: wherein:
elimination of wires snagging on external objects that may cause damage to a wired personal electronic device or damage to the external object.

9. The Wireless Personal Listening Device provides an increase in personal convenience.
